(19) United States
(12) Patent Application Publication
(10) Pub. No.: US 2007/0299716 A1
(43) Pub. Date: Dec. 27, 2007

(54) Method and system for forecasting demand of rotable parts

(75) Inventors: Bret Allen Shorter, Morton, IL (US); Cassandra Lea Osborne, East Peoria, IL (US); Amy Michelle Ahlers, Morton, IL (US); Christopher Paul Kopinski, Peoria, IL (US); Jennifer Katherine Aspinall, East Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/607,740

(22) Filed: Nov. 30, 2006

Related U.S. Application Data
(60) Provisional application No. 60/816,313, filed on Jun. 26, 2006.

(51) Int. Cl. G06F 17/30

(52) U.S. Cl. 705/10

(57) ABSTRACT

A method for forecasting a demand for rotable parts includes collecting demand data for one or more rotable parts associated with a product inventory. A demand pattern associated with the demand data is identified for each of the one or more rotable parts. A future demand associated with the one or more rotable parts is forecasted for at least one future demand period based on the identified demand pattern. An inventory level associated with each of the one or more rotable parts is established, for the at least one future demand period, a based on the future demand and a predetermined customer service level. The method also includes adjusting a manufacturing schedule associated with the one or more rotable parts based on the established inventory level.

This application claims priority to and the benefit of the filing date of U.S. Provisional Patent Application No. 60/816,313, filed Jun. 26, 2006, which is herein incorporated by reference in its entirety.

### TECHNICAL FIELD

The present disclosure relates generally to inventory management processes for supply chain environments and, more particularly, to methods and systems for forecasting demand of rotable parts.

### BACKGROUND

Inventory tracking and management systems are invaluable tools for optimizing stock levels for parts dealers. If stock levels are too low, a dealer could lose sales as would be customers take their business elsewhere. The loss of business could be even greater if the customer decides to take all of their future business elsewhere. If stock levels are too high, the dealer could incur extra costs associated with maintaining excess stock (e.g., higher costs for larger storage space, higher insurance costs, etc.).

An accurate forecast of the demand for parts may facilitate a determination of optimum stock levels. It is further helpful to obtain demand forecast data separately indicating data for various categories or types of part, as there may be several versions of a particular part. For example, the same part may be available in both a new version and a used version that has been refurbished in some way (e.g., repaired, remanufactured, overhauled, etc.). Such used but refurbished parts are known as rotable parts and are often sold on an exchange basis. When parts are sold on an exchange basis through an exchange program, customers who have a part that is at or near the end of its useful life may, when purchasing a replacement part, turn in (exchange) the part that they wish to replace. The seller may then refurbish the part that was turned in and resell it as part of a future exchange transaction.

While there are many systems for tracking inventory of and/or forecasting demand for new parts, these systems do not forecast demand for rotable parts (e.g., no prediction is made for future demand for parts sold on an exchange basis). Systems have been developed that attempt to optimize stock levels for rotable parts. For example, U.S. Patent Application Publication No. 2005/0177.467 by Wang et al. (“the '467 document”) discloses a rotable inventory calculation method. The '467 document teaches determining optimum stock levels for parts based on the likelihood that parts that have been turned in by customers for repair can be repaired within the timeframe requested (or contracted) by the customer. The '467 document suggests that the more frequently repairs are not able to be made within the desired time period, the more parts (of any type, e.g., rotable or new) should be kept in stock to be provided to customers in the event that the repair of their part is not completed within the desired time period.

Although the method described in the '467 document may attempt to estimate optimum rotable inventory stock levels based on a desired customer lead time, it may be inefficient and unreliable. For instance, while the method of the '467 document may determine an amount of rotable inventory to keep in stock to meet rotable part repair requests based on repair lead time, it fails to address demand fluctuations associated with new rotable parts requests. As a result, should new customers request rotable parts, the method of the '467 document may not stock the inventory necessary to meet the demand associated with the rotable part requests from new customers in addition to the rotable part repair requests from existing customers.

The presently disclosed method and system for forecasting demand of rotable parts is directed toward overcoming one or more of the problems set forth above.

### SUMMARY OF THE INVENTION

In accordance with one aspect, the present disclosure is directed toward a method for forecasting a demand for rotable parts. The method may include collecting demand data for one or more rotable parts and analyzing the collected demand data based on historical demand data. A demand pattern associated with the demand data for each of the one or more rotable parts may be identified based on the analysis, and future demand data associated with the one or more rotable parts for at least one future demand period may be predicted based on the identified demand pattern. The method may also include establishing, for the at least one future demand period, an inventory level associated with each of the one or more rotable parts based on the future demand data and a predetermined customer service level. The method may also includes adjusting a manufacturing schedule associated with the one or more rotable parts based on the established inventory level.

According to another aspect, the present disclosure is directed toward a method for forecasting a demand for rotable parts. The method may include collecting demand data for one or more rotable parts associated with a product inventory and identifying whether there are any superseding parts corresponding with the one or more rotable parts. For each rotable part with a corresponding superseding part, the demand data for the rotable part may be recorded as demand data associated with the superseding part. The collected demand data may be analyzed based on historical demand data, a demand pattern associated with the demand data may be identified based on the analysis, and future demand data associated with each of the rotable parts and superseding parts for at least one future demand period may be predicted based on the identified demand pattern. The method may also include establishing, for the at least one future demand period, an inventory level associated with each of the rotable parts and the superseding parts based on the future demand data and a predetermined customer service level.

In accordance with yet another aspect, the present disclosure is directed toward a computer-readable medium for use on a computer system, the computer-readable medium having computer-executable instructions for performing a rotable part demand forecasting method. The method may include collecting demand data for one or more rotable parts associated with a product inventory and analyzing the collected demand data with historical demand data. A demand pattern associated with the demand data for each of the one or more rotable parts may be identified based on the analysis, and future demand data associated with the one or more rotable parts for at least one future demand period may be predicted based on the identified demand pattern. The method may also include establishing, for the at least one future demand period, an inventory level associated with each of the one or more rotable parts based on the future demand data and a predetermined customer service level.

According to yet another aspect, the present disclosure is directed toward a part demand forecasting method. The method may comprise collecting information about at least one sales transaction including recording, from each sales transaction, a customer request for a part; and recording whether or not the customer is willing to purchase the part on an exchange basis by exchanging a used version of the requested part as part of the sales transaction. The method may also include forecasting demand for rotable parts based on the collected information, and displaying information regarding the forecasted demand.

### BRIEF DESCRIPTION OF THE DRAWINGS

FIG. 1 illustrates an exemplary supply chain management environment in which processes and methods consistent with the disclosed embodiments may be implemented;

FIG. 2 provides a schematic illustration of an exemplary inventory management system in accordance with certain disclosed embodiments;

FIG. 3 is a table including exemplary data that may be collected from sales transactions according to an exemplary disclosed embodiment;

FIG. 4 is a flow chart illustrating logic for determining and recording demand for rotable parts according to an exemplary disclosed embodiment;

FIG. 5 is a flow chart, continued from the flow chart in FIG. 4, illustrating logic for determining and recording demand for new parts according to an exemplary disclosed embodiment;

FIGS. 6A-6E are exemplary historical demand pattern models that may be utilized by an exemplary disclosed embodiment of the disclosed rotable parts demand forecasting system;

FIG. 7 is a timeline indicating lead time for repair of rotable parts according to an exemplary disclosed embodiment;

FIG. 8 is a look-up table which relates inventory stock levels of rotable parts with customer service levels according to an exemplary disclosed embodiment; and

FIG. 9 provides a flowchart depicting an exemplary method for forecasting a demand for rotable parts consistent with certain disclosed embodiments.

### DETAILED DESCRIPTION

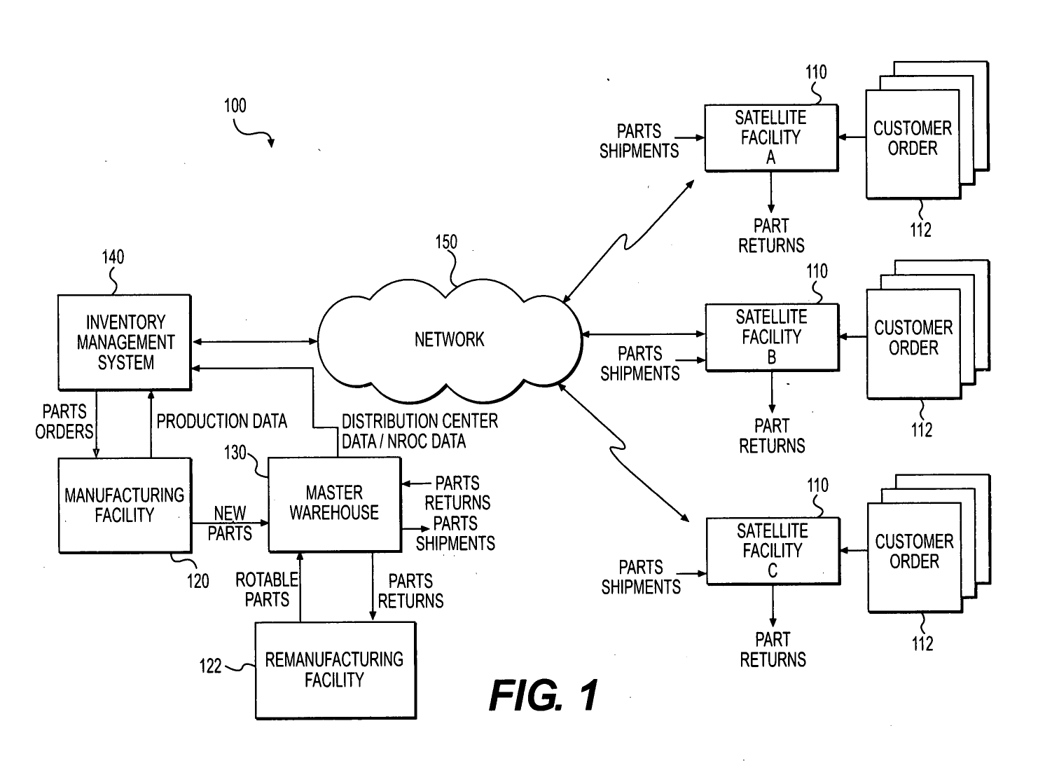

FIG. 1 illustrates an exemplary supply chain management environment 100 in which methods and processes consistent with the disclosed embodiments are implemented. Supply chain management, as the term is used herein, refers to any process or system involved in the production, shipment, distribution, sale, tracking, or storage of goods between or among raw material suppliers, distributors, manufacturers, retailers, and customers. Furthermore, supply chain management may include quality control processes, logistics management processes, inventory management processes, and/or account management processes, associated with the flow of data and materials within a particular supply chain. According to one embodiment, and as illustrated in the FIG. 1, supply chain management environment 100 may include systems associated with one or more satellite facilities 110, one or more manufacturing (and/or remanufacturing) facilities 120, one or more master warehouses 130, and an inventory management system 140. These systems may be communicatively coupled to one or more other systems associated with supply chain management environment 100 via communication network 150. It is contemplated that, although the present disclosure may describe certain processes and functions as being performed by one or more facilities or warehouses described above, these processes and functions may be performed manually (e.g., by personnel associated with the respective facility) and/or electronically, by one or more computer systems associated with a respective facility.

Satellite facility 110 may include a computer system for receiving, analyzing, tracking, updating, and/or processing customer part requests. For example, satellite facility 110 may be associated with a retail or wholesale parts facility responsible for receiving and filling customer part orders; monitoring and maintaining local inventory levels; collecting and managing part returns, including new part returns, core returns, used part returns, etc.; filling part exchange requests; and/or receiving part shipments from one or more other facilities (e.g., manufacturing/remanufacturing facilities, distribution centers, regional warehouse storage facilities, and/or other part supplier facilities). According to one embodiment, a computer system associated with satellite facility 110 may monitor, record, and analyze data associated with each type of transaction (sales, returns, exchanges, core deposits, repairs, re-certifications, etc.) of the part supplier facility. This data may be periodically or continuously uploaded into a central backend system, such as inventory management system 140.

Manufacturing facility 120 may include a computer system for monitoring, analyzing, and/or recording data associated with the manufacturing of new parts or the repair, recertification, or remanufacturing of used parts. For example, manufacturing system 120 may be associated with a part manufacturing plant involved in the assembly, repair, manufacturing, remanufacturing, and/or re-certification of parts for eventual consumption by an end user. According to one embodiment, a computer system associated with manufacturing system 120 may embody a computer system configured to monitor, analyze, record, and/or control one or more aspects associated with the operation of the manufacturing plant.

As illustrated in FIG. 1, manufacturing facility 120 may be configured to manage inventory associated with the manufacturing plant. For example, manufacturing system 120 may be configured to monitor and track the receipt of parts returned by one or more customers, monitor the shipment of rotable and/or new parts to one or more distribution centers, monitor and adjust the production level associated with the manufacture of new parts and/or the remanufacture, repair, or recertification of used. Manufacturing system 120 may be configured to continuously or periodically provide manufacturing system data to inventory management system 140.

Master warehouses 130 may include a computer system for monitoring and managing inventory associated with one or more distribution centers. For example, master warehouses 130 may be adapted to monitor and track the receipt of parts (e.g., new parts, rotable parts, etc.) from a manufacturing plant, as well as the shipment and distribution of parts from the distribution center. Rotable parts, as the term is used herein, refers to any part that is manufactured in such a way that the part (or a component thereof) may be repaired, remanufactured, or overhauled in such a way so as to reset at least a portion of the usable life thereof.

Inventory management system 140 may include an electronic system configured to monitor and record inventory data associated with supply chain environment 100. For example, the inventory management system 140 may be communicatively coupled to one or more of satellite facility 110, manufacturing system 120, and distribution system 130. Inventory management system 140 may collect inventory data associated with each respective system, monitor and control the flow of inventory between or among each system, and adapt supply chain resources to ensure the appropriate operation of supply chain environment 100.

According to one embodiment, inventory management system 140 may receive data associated with a satellite facility from a corresponding satellite facility 110 and store the data in memory for future analysis. For example, inventory management system 140 may receive customer orders from a satellite facility. Customer orders may include, among other things, information identifying a requested part, a desired quantity associated with a requested part, a desired part condition associated with a requested part (e.g., new, re-certified, repaired, remanufactured, etc.) and information that may correspond to a return transaction associated with the customer order (e.g., whether the order includes an accompanying core return, rental return, repair and/or overhaul part return). This information may be stored in an inventory management database associated within the inventory management system 140 for future analysis.

The inventory management system 140 may be adapted to monitor, analyze, and record data received from manufacturing facility 120 (via a computer system associated therewith) and provide commands to manufacturing facility 120 for adjusting productivity levels of the manufacturing plant to meet customer demand. It is contemplated that inventory management system 140 may adjust the levels associated with both new and rotable parts. For instance, inventory management system 140 may reduce the level of production for new parts associated with a particular part number based on a decrease in demand for new parts. Alternatively and/or additionally, inventory management system 140 may increase the level of remanufactured parts from core materials, based on an increase in customer demand for remanufactured parts.

Inventory management system 140 may be configured to account for part supersession. For example, in the event that a product has been replaced by a different part (e.g., superceded) or happens to be interchangeable with a different part, inventory management system 140 may be configured to roll demand to the different part before executing the forecast. This will ensure that the latest part that the vendor supports will be the part for which the demand is forecast.

In addition, demand may be scaled depending on how many days within a predetermined forecast period the part could be purchased (e.g., how many days the seller was open for business). For example if a facility is only open for 15 days in a month-long forecast period, then the demand will be scaled to 15 days in order to make the monthly periods comparable. In one embodiment, the demand for each month may be determined on a “per business day” basis. That is, the total number of entries (requests) for a part during each month may be divided by the total number of days that the seller was open for business to determine the total number of entries per business day. This type of value may facilitate comparisons between monthly demand. Other scaling models may also be used.

Inventory management system 140 may be configured to control excessive demand entries by maintaining predetermined entry limits (e.g., maximum and/or minimum allowable number of entries during a forecast period), in order to prevent a forecast from overreacting to extreme deviations from historical demand/entries in any one period. However, in some embodiments, if an entry limit is reached on a consistent basis (e.g., in more than a predetermined number of consecutive periods, wherein the number may be selectable), a forecast recalculation (trip) may be made by inventory management system 140 to bring the forecast in line with the actual demand/entries instead of the limited values.

In order to forecast demand over a predetermined time period, historical data may also be considered. For example, statistical smoothing may be utilized to lessen the impact of spikes or sharp drops in demand data on the forecast. For example, once any entry/demand limits have been applied, a forecasting model may be chosen to be applied to the acquired demand data. The forecasting model may be chosen based on historical demand/entry data to determine which forecast model best fits the demand pattern recorded for the part. For example, the demand pattern over the last 2 years may be analyzed. Inventory management system 140 may chose from any number of models, for example, lumpy, random, trend, seasonal, and declining growth rate. Once a periodic (e.g., monthly) forecast has been created, an output array may be generated for the part. Based on the forecast model chosen, the output array may include a demand forecast for a predetermined period of time (e.g., the next twelve to twenty-four months of expected demand for the part).

In one example, if the chosen model is a positive trend, then the first monthly forecast may be the calculated forecast and each subsequent month may be higher than the last and may align with the calculated slope. This type of forecast may be determined for a specific (modifiable) number of periods into the future. In a second example, if a seasonal model is chosen, the output array for the next year may reflect application of the detected seasonal pattern to the forecast data. This is the general forecasting process and is not specific to rotables forecasting.

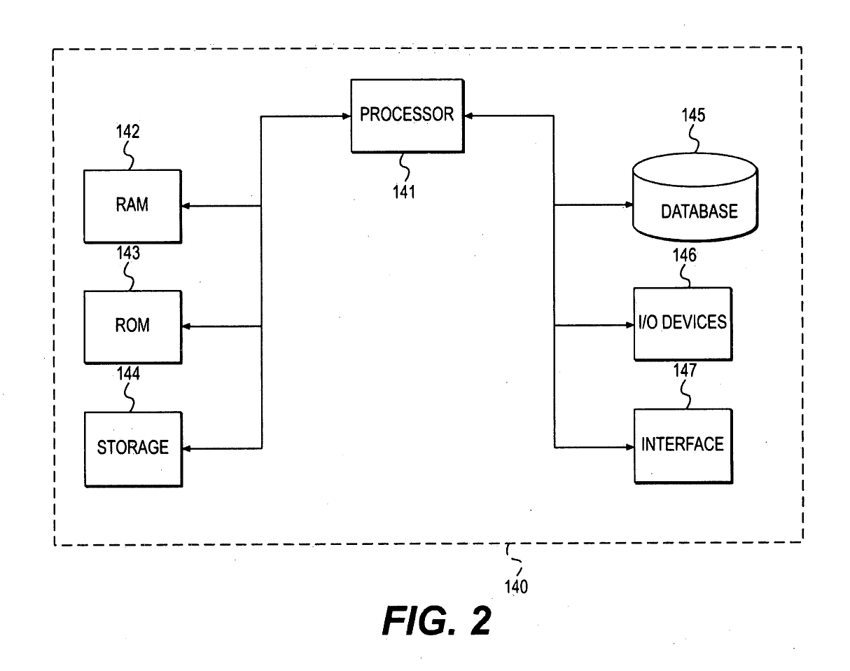

Inventory management system 140 may include any type of processor-based system on which processes and methods consistent with the disclosed embodiments may be implemented. For example, as illustrated in FIG. 2, inventory management system 140 may include one or more hardware and/or software components configured to execute software programs, such as software for managing supply chain environment 100, inventory monitoring software, or inventory transaction software. For example, inventory management system 140 may include one or more hardware components such as, for example, a central processing unit (CPU) 141, a random access memory (RAM) module 142, a read-only memory (ROM) module 143, a storage system 144, a database 145, one or more input/output (I/O) devices 146, and an interface 147. Alternatively and/or additionally, inventory management system 140 may include one or more software components such as, for example, a computer-readable medium including computer-executable instructions for performing methods consistent with certain disclosed embodiments. It is contemplated that one or more of the hardware components listed above may be implemented using software. For example, storage 144 may include a software partition associated with one or more other hardware components of inventory management system 140. Inventory management system 140 may include additional, fewer, and/or different components than those listed above. It is understood that the components listed above are exemplary only and not intended to be limiting.

CPU 141 may include one or more processors, each configured to execute instructions and process data to perform one or more functions associated with inventory management system 140. As illustrated in FIG. 2, CPU 141 may be communicatively coupled to RAM 142, ROM 143, storage 144, database 145, I/O devices 146, and interface 147. CPU 141 may be configured to execute sequences of computer program instructions to perform various processes, which will be described in detail below. The computer program instructions may be loaded into RAM for execution by CPU 141.

RAM 142 and ROM 143 may each include one or more devices for storing information associated with an operation of inventory management system 140 and/or CPU 141. For example, ROM 143 may include a memory device configured to access and store information associated with inventory management system 140, including information for identifying, initializing, and monitoring the operation of one or more components and subsystems of inventory management system 140. RAM 142 may include a memory device for storing data associated with one or more operations of CPU 141. For example, ROM 143 may load instructions into RAM 142 for execution by CPU 141.

Storage 144 may include any type of mass storage device configured to store information that CPU 141 may need to perform processes consistent with the disclosed embodiments. For example, storage 144 may include one or more magnetic and/or optical disk devices, such as hard drives, CD-ROMs, DVD-ROMs, or any other type of mass media device.

Database 145 may include one or more software and/or hardware components that cooperate to store, organize, sort, filter, and/or arrange data used by inventory management system 140 and/or CPU 141. For example, database 145 may include historical data such, for example, historic inventory fluctuations and/or past customer order data. CPU 141 may also analyze current and previous inventory demand records to identify trends in inventory count adjustment. These trends may then be recorded and analyzed to adjust one or more aspects associated with an inventory control process, which may potentially reduce inventory management errors, washout, and/or product over- or under-stocking. It is contemplated that database 145 may store additional and/or different information than that listed above.

I/O devices 146 may include one or more components configured to communicate information with a user associated with inventory management system 140. For example, I/O devices may include a console with an integrated keyboard and mouse to allow a user to input parameters associated with inventory management system 140. I/O devices 146 may also include a display including a graphical user interface (GUI) for outputting information on a monitor. I/O devices 146 may also include peripheral devices such as, for example, a printer for printing information associated with inventory management system 140, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 147 may include one or more components configured to transmit and receive data via a communication network, such as the Internet, a local area network, a workstation peer-to-peer network, a direct link network, a wireless network, or any other suitable communication platform. For example, interface 147 may include one or more modulators, demodulators, multiplexers, demultiplexers, network communication devices, wireless devices, antennas, modems, and any other type of device configured to enable data communication via a communication network.

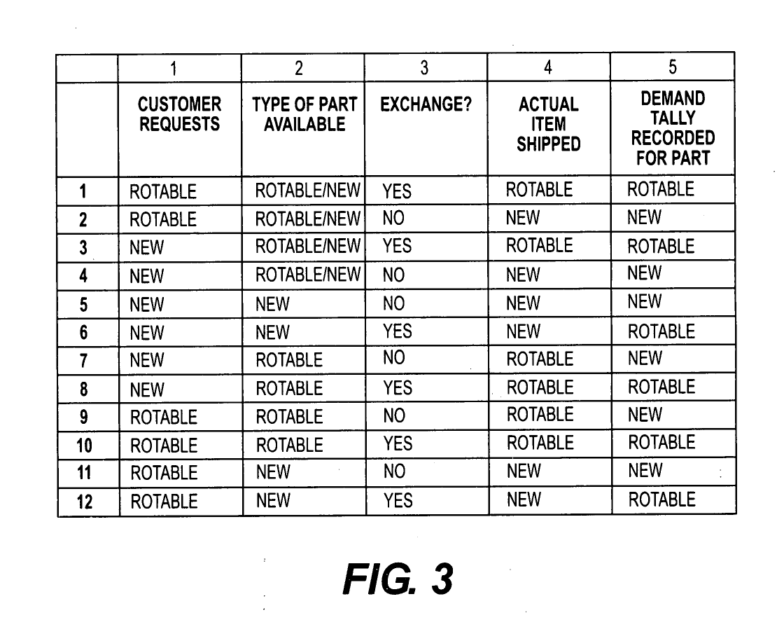

FIG. 3 is a data chart indicating the type of information that may be collected from each sales transaction and lists the type of demand tally associated with a number of different types of transactions. This demand tally is representative of the type of part that should be stocked in order to meet the customer's demand under the given scenario.

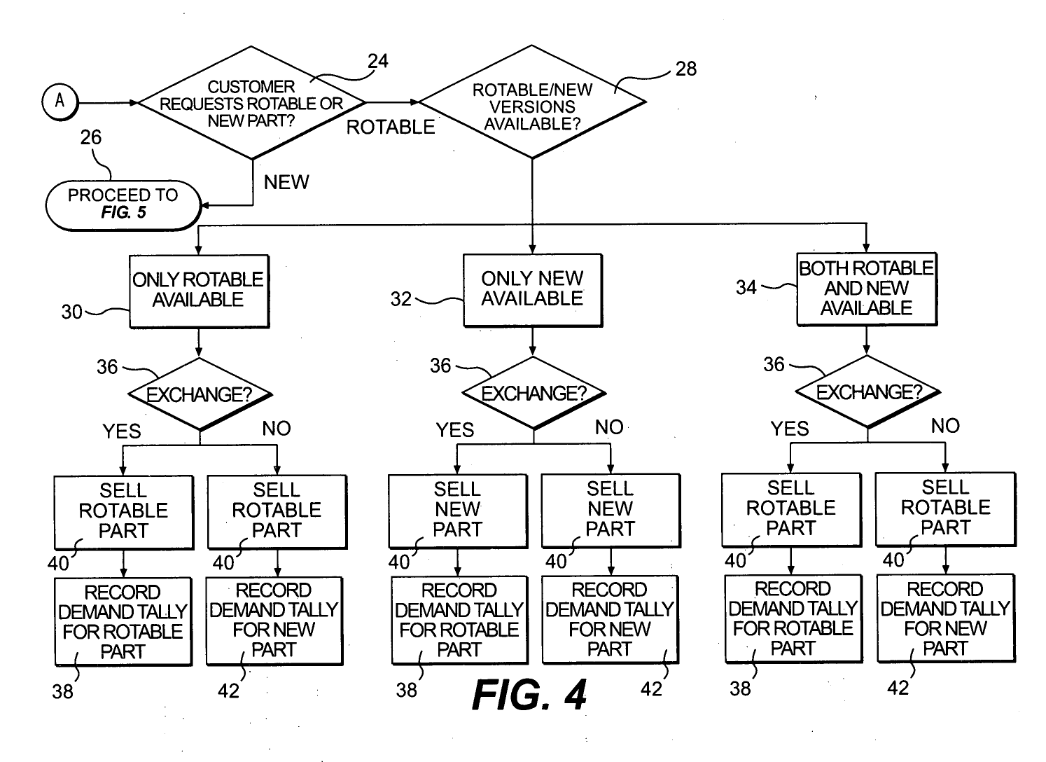

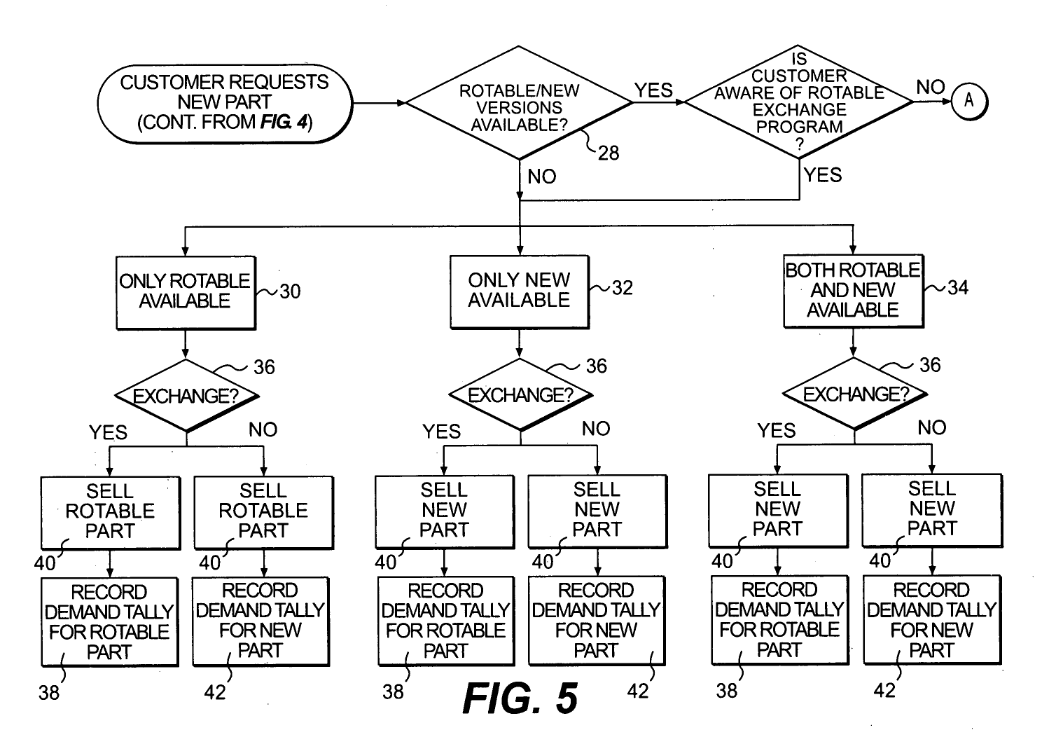

FIG. 4 and FIG. 5 are flowcharts, which illustrate exemplary logic that may be followed to collect information from each sales transaction and to forecast demand for parts based on that information. The information collecting performed as part of the part demand forecasting method may include recording, from each sales transaction, a customer request for a part, including whether the customer requested a new version of the part or a rotable version of the part (see FIG. 3, col. 1; FIG. 4, step 24). If the customer requests a new part, then the logic proceeds to FIG. 5 (step 26). If the customer requests a rotable part, the logic proceeds to step 28. At step 28, part availability for the requested part may be determined and recorded. Such a determination may include an assessment of whether a rotable version of the requested part is available (step 30), a new version of the requested part is available (step 32), or both (step 34) are available for sale to the customer at the time of the request or within a predetermined time period thereafter.

The collecting of information may also include recording whether or not the customer is willing to purchase the part on an exchange basis by exchanging a used version of the requested part as part of the sales transaction (FIG. 3, col. 3; FIGS. 4 and 5, step 36). It should be noted that, in certain embodiments, the customer's willingness to exchange an old part as part of the transaction may override their request for a rotable or new part. For example, business practice may dictate that no new parts will be sold on an exchange basis. Therefore, even if a customer requests a new part, if they then indicate a willingness to make an exchange, then they will be sold a rotable (remanufactured) part if one is available. Under such a business policy, any sale of a part (rotable or new) on an exchange basis may be recorded as a demand tally for a rotable part (step 38). Some business models may allow for regular sale of new parts on an exchange basis, regardless of whether the seller has stock of rotable or new versions of the part. Similarly, some business models may allow for regular sale of rotable parts on a “straight buy” basis (i.e., not involving an exchange) regardless of whether new versions of the requested parts are available for sale.

The present disclosure and accompanying figures are directed to exemplary business models wherein a customer's willingness to purchase on an exchange basis is determinative of whether the sales transaction results in a recording of a demand tally for a new or rotable part. However, as discussed above, the presently disclosed system may be applicable to other business models.

With further regard to FIG. 3, the type of part that is actually shipped under each scenario is indicated in the column 4 (see also FIGS. 4 and 5, step 40), and column 5 indicates the demand tally that may be recorded for each scenario. For example, in row 7, the customer wanted a new part but only a rotable version was available. Because the customer was not willing to exchange, a rotable part was sold to them without any exchange. Even though a rotable part was shipped, the demand tally is recorded as “new” because the customer actually wanted a new part and was unwilling to exchange an old part.

One or more software application associated with inventory management system 140 may be configured to perform a method that includes recording a rotable part entry tally for each part sold on an exchange basis (step 38). The method may further include forecasting demand for new parts based on the recorded information. Forecasting demand for new parts may involve recording a new part entry tally for each part sold on a straight buy basis (step 42). Forecasting demand may include determining a total number of rotable part entry tallies recorded during a predetermined time period.

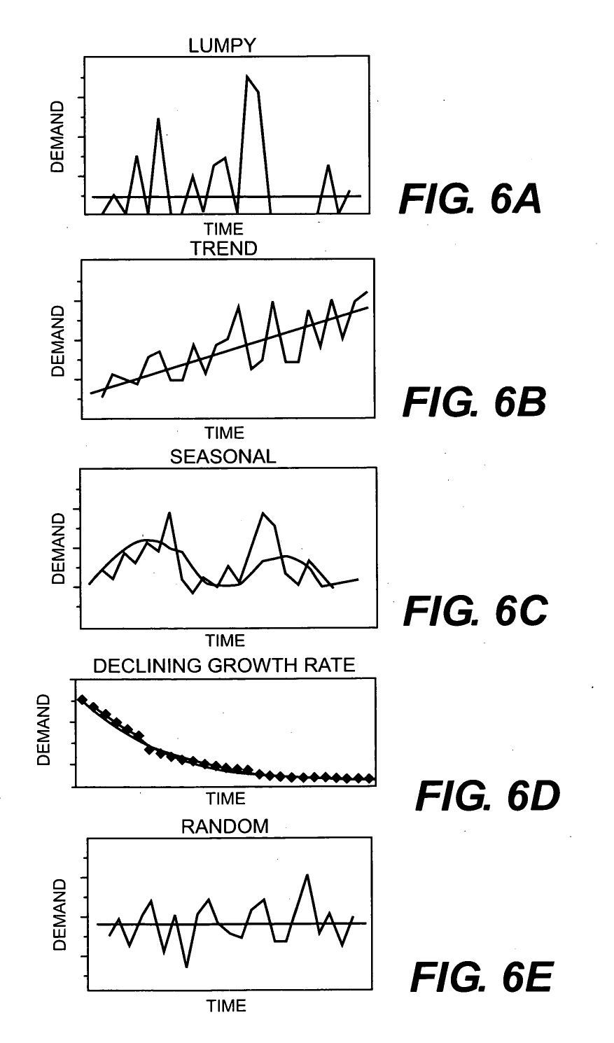

FIGS. 6A-6E illustrate exemplary patterns that fit some of these models. FIG. 6A illustrates an exemplary “lumpy” demand pattern. Parts with lumpy demand patterns may demonstrate a pattern of being extremely slow moving. For example, such parts may, over twelve month-long forecast periods, have six or more periods without a customer requesting the part. In another example, such parts may, over twenty-four month-long forecast periods, have eleven periods without a customer requesting the part.

FIG. 6B illustrates an exemplary “trend” demand pattern. Parts for which demand follows a trend pattern may show a detectable slope in the demand, e.g., when reviewed month to month. This slope can be either positive or negative.

FIG. 6C illustrates an exemplary “seasonal” demand pattern. Parts for which demand follows a seasonal pattern may have a detectable pattern in the demand that is repeated year after year. There may be multiple rules that review the patterns of these items because the seasons can shift slightly from year to year based on external factors.

FIG. 6D illustrates a “declining growth rate” demand pattern. Parts that exhibit a declining growth rate in demand may be nearing the end of their useful life. This model may determine the rate at which the demand for such parts is declining and may attempt to best fit a declining curve to the forecast.

FIG. 6E illustrates an exemplary “random” demand pattern. The random model may be the default model used if the demand pattern for a particular part does not fit other models, such as those discussed above.

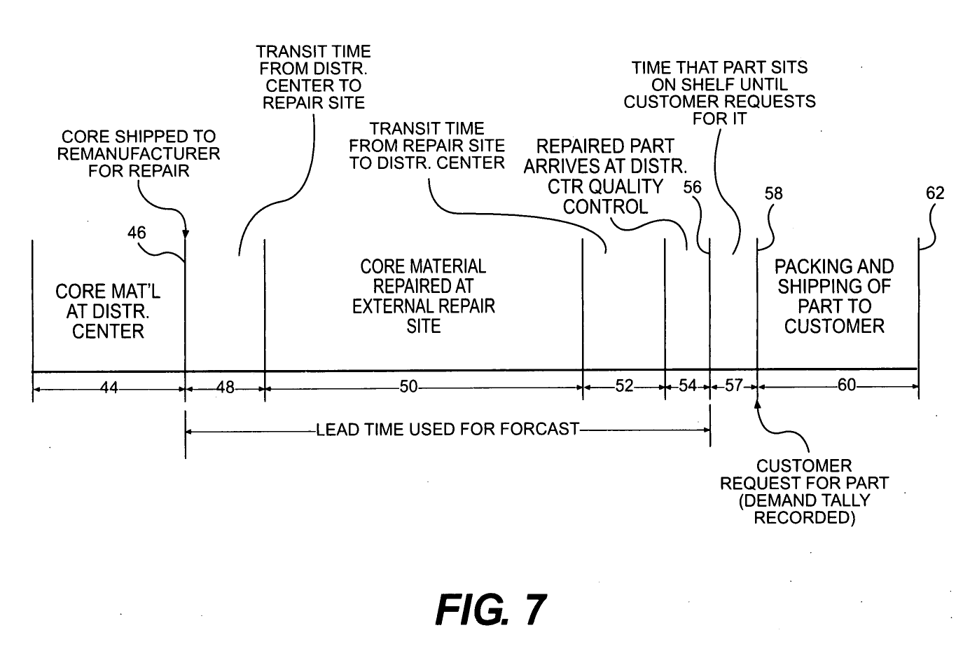

Forecasting may utilize a remanufacturing lead time for the requested part. The remanufacturing lead time may include the time periods for various steps in the remanufacturing process, namely, how long it takes to repair a rotable part. FIG. 7 is a time line illustrating various steps in an exemplary remanufacturing process. The time periods illustrated and discussed with regard to FIG. 7 are intended to be exemplary only. Such time periods may vary from one application to another. The time periods illustrated in FIG. 7 are not intended to be proportional to the amounts of time that they respectively represent.

As illustrated in FIG. 7, a first time period 44 indicates the amount of time a core material or part (i.e., a part that is in need of repair) remains at a distribution center (e.g., in seller's possession). At some point in time 46, the core may be shipped to a remanufacturer for repair. Time period 48 indicates the amount of time that the core may be in transit from the distribution center to the repair site (i.e., the remanufacturer). Time period 50 indicates the amount of time that the core material remains in the possession of the remanufacturer until it is repaired. Time period 52 indicates the transit time from the repair site back to the distribution center. When the repaired part arrives back at the distribution center, it may spend some time in a quality control process. Once the quality control process is completed, the part may, at point in time 56, be ready and available for resale to requesting customers. In an exemplary embodiment, the total time between point in time 46 and point in time 56 may be the remanufacturing lead time used for demand forecasting. Once the repaired part is available for sale, time period 57 indicates the amount of time the part sits on a shelf (or otherwise remains in stock) until a customer makes a request for it at point in time 58.

In some cases, the requested part may be available for off-the-shelf purchase at point in time 58. However, other parts may require a period of time 60 for packing and/or shipping of the part to the customer.

Packing and shipping times may be fairly consistent and, therefore, predictable. Therefore, if the part is readily available at the time of customer request, then delivery within the agreed upon delivery time may be quite achievable on a consistent basis. However, if the part is not available at the time of customer request, there may be some delay in delivery, which could reduce the level of customer service provided by the seller. The disclosed demand forecasting system may be configured to determine the number of parts that, if maintained in stock, will enable the seller to provide a predetermined level of customer service. For example, if the predetermined customer service level is 92%, inventory management system 140 may be configured to estimate a number of parts that, if maintained in stock, will rarely (i.e., less than 8% of the time in this case) be depleted such that a customer would have to wait for additional parts to complete the remanufacturing process.

In some embodiments, the target customer service level may be set globally or otherwise across many different parts. For example, the target customer service level may be set at 92% for all service from warehouse A for a particular part type or sub-type. Part type and sub-type could be configured to account for any number of item indicative characteristics.

Forecasting demand may also include determining a forecast of entries during the lead time of a part where an “entry” is the number of requests for a particular part entered by the customer or seller into the system. The lead time forecasted entry value for a rotable part may be determined based on the total number of rotable part entry tallies expected during a predetermined demand forecasting time period. This total may be extrapolated or interpolated to yield a number of rotable part demand tallies corresponding to the remanufacturing lead time for the part. For example, if the demand forecasting time period (i.e., the period of time over which demand is recorded) is 30 days, but the remanufacturing lead time for a particular part is only 15 days, then, by interpolation, the lead time forecast entry value will be half of the total forecasted entries expected over the 30 day period. Similarly, if the forecast covers a 30 day periods of time, but the remanufacturing lead time for a particular part is 60 days, then, by extrapolation, the lead time forecast entry value will be twice the forecasted entries over the 30 day period.

The lead time forecast entry value may be used in a Poisson forecast calculation to determine the number of rotable versions of the part that should be maintained in stock in order to meet a predetermined level of customer service. An exemplary version of a Poisson forecast equation may include the following:

$$CSL = {E}^{{FENT}_{LT}} \cdot \frac{{FENT}_{LT}^{K 4}}{FACT ( K 4 )}$$

where CSL is the desired customer service level, FENT_{LT} is the lead time forecast entry value, FACT(K4) is the factorial calculation of a particular stock level, K4.

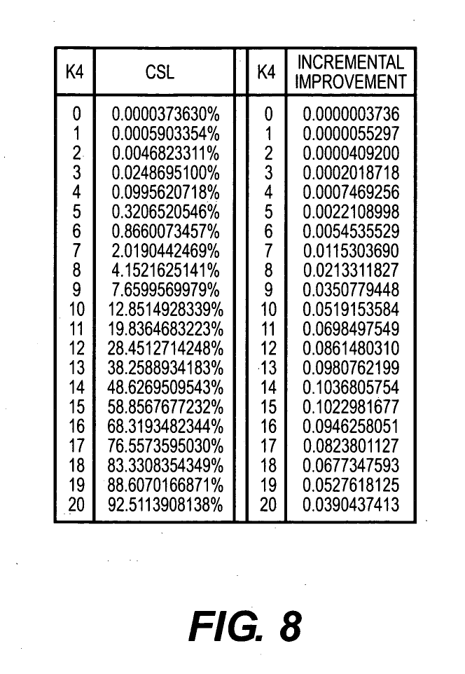

FIG. 8 illustrates an exemplary table that may be generated and/or referenced, which indicates the cumulative customer service level (CSL)(i.e., the probability, expressed as a percentage, that the seller will be able to provide a customer with the requested part within the requested, contracted, or otherwise agreed upon time period) that may be achieved by maintaining different stock levels (K4). The equation above and the lookup table illustrated in FIG. 5 may be used to determine K4 (i.e., the number of parts that should be kept in stock to meet the desired CSL). FIG. 8 also lists, for reference, examples of incremental customer service level improvement associated with each additional part kept in stock (i.e., K4).

This process may calculate the amount of material to stock to cover the lead-time of repair as well as safety stock requirements. Safety stock is the amount of stock required, above and beyond that needed to cover the lead-time of repair, to meet the target customer service level. Additional safety stock may be added if the demand pattern has sufficiently high standard deviation. That is, if the historical demand pattern lacks consistency, then inventory management system 140 may add additional safety stock in case an unexpectedly high demand arises.

The general flow of the forecast process may include the following. A customer may request a part. Based on this request, demand/entry data may be captured (i.e., “entered”). Such demand/entry data may be accumulated throughout a predetermined forecast period. Supersession may be applied to the demand, as discussed above. Further, demand may be scaled to reflect the number of activity days in the forecast period. Demand/entry limits may be applied. In addition, a best fit forecast model may be selected. The forecast may be executed (including exponential smoothing of new data with the historical forecast). From this forecast, an output array may be generated to extrapolate forecast out through the next predetermined time period (e.g., 12-24 months). In some embodiments, inventory management system 140 may be associated with a replenishment module configured to determine how to establish the stock levels recommended by inventory management system 140. Output to the replenishment module may include the output array and safety stock value determined through the Poisson process.

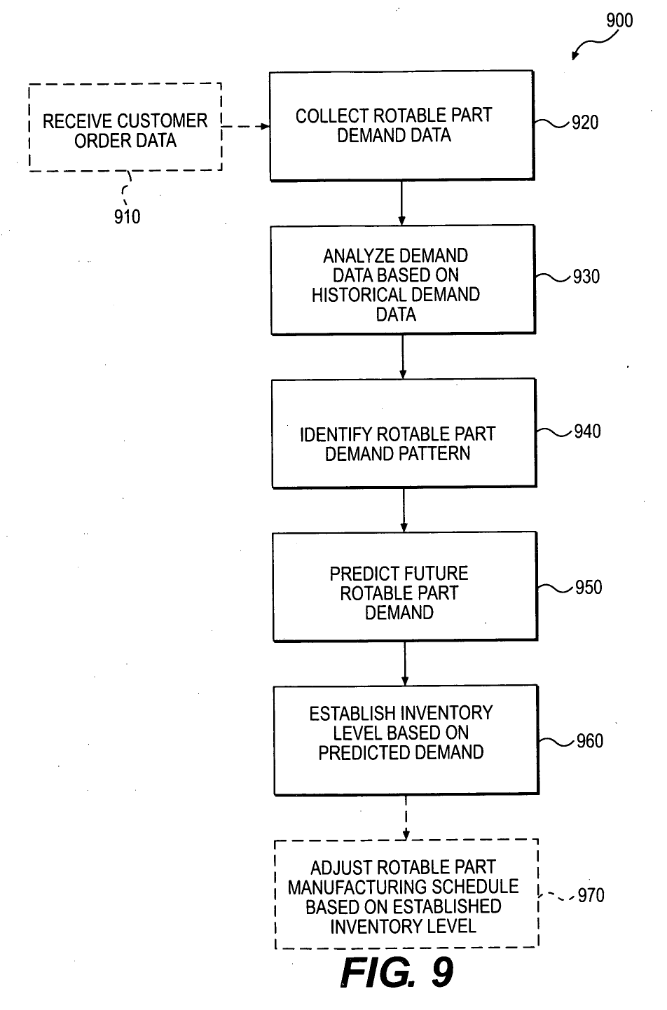

Processes and methods consistent with the disclosed embodiments may enable inventory managers to more accurately and efficiently forecast customer demand associated with rotable parts, thereby providing a mechanism for establishing rotable inventory levels sufficient to meet customer demand for new rotable part orders and rotable repairs. FIG. 9 provides a flowchart 900 depicting an exemplary method for estimating rotable part demand. As illustrated in FIG. 9, inventory management system may receive customer order data (Step 910) and derive rotable part demand data (Step 920) from the customer order data. For example, a customer may, as part of a product exchange program, return a used or expired part and request a rotable part in exchange for the returned part. Based on the customer order information, inventory management system may derive demand data associated a rotable part. As previously explained, customer order data may include, among other things, one or more parts requested by a customer, a part condition associated with the requested part (e.g., new, remanufactured, repaired, overhauled, used, etc.), and any part return information that may correspond with the part condition (e.g., core return, rental return, etc.). It is contemplated that, although rotable part demand data is described as being derived from customer order information, it may be collected or derived from one or more other sources and/or rolled over from one or more older (i.e., discontinued or updated) parts.

Once the rotable part demand data has been collected, inventory management system 140 may analyze the demand data based on historical demand data (Step 930). A rotable part demand pattern may be identified (Step 940) based on the demand data analysis. Inventory management system 140 may select a predetermined demand model that most closely fits the identified demand pattern.

Upon identifying the inventory demand pattern, inventory management system 140 may predict a future rotable part demand (Step 950). For instance, the identified demand pattern may be extrapolated over one or more future demand periods to forecast future demand data for the corresponding future demand periods. As demand trends change, the forecast demand data associated with the rotable parts may change accordingly. As product lines develop, demand for older, retired product lines may be rolled into updated (i.e., superceding) product lines.

Once the future demand for one or more rotable parts has been forecasted, inventory management system 140 may establish a minimum inventory level for each of the rotable parts based on the forecasted demand (Step 960). For instance, inventory management system 140 may determine a inventory level associated with each rotable part, wherein the inventory level dictates the optimum quantity of a particular part needed to meet a future customer demand. This inventory level may factor in a customer service level, defined as a percentage confidence that a particular rotable part will be available for sale at any particular time. A customer service level of 90% may indicate that the rotable part should be in stock to meet at least 90% of the demand for the particular part. It is contemplated that different customer service levels may be established for certain part types.

According to one embodiment, inventory management system 140 may adjust a purchasing schedule associated with one or more rotable parts based in the inventory level (Step 970). For example, should the inventory demand analysis prompt in increase in the inventory level associated with one or more rotable parts, inventory management system 140 may transmit a purchasing schedule which prompts a production increase to manufacturing system 120.

### INDUSTRIAL APPLICABILITY

The disclosed system may be used to manage inventory for any rotable parts exchange program. It should be noted that although rotable parts may include various parts and components of larger machines, equipment, or devices, the disclosed system could be implemented for managing inventory of rotable versions of complete machines, equipment, or devices. Therefore “rotable parts,” as referred to herein shall be understood to encompass both complete machines and components of machines.

In addition, although the disclosed system is discussed in the context of parts exchange programs involving purchase/sale transactions, the disclosed system may also be applicable to machine/tool rental programs. In a rental program, rented equipment may, upon return, need to be serviced and, in some cases, recertified before being rented to another customer. Therefore, a rental program involves taking possession of a tool by the customer, turning it back in to the renter, and servicing/repairing the tool by the renter prior to renting it again. In this sense, rental programs are effectively exchange programs, except that in a purchase/sale program, the customer takes possession of the part and turns in the old part being replaced at the same time, whereas in a rental program, there is a time gap (the rental period) between taking possession of the tool and turning in the tool (which happens to be the same tool). Therefore, a “rotable parts exchange program,” as referred to herein, shall be understood to encompass purchase/sale exchange programs, rental programs, lease programs, and the like.

It will be apparent to those having ordinary skill in the art that various modifications and variations can be made to the disclosed rotable part demand forecasting system without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A method for forecasting a demand for rotable parts comprising:
collecting demand data for one or more rotable parts associated with a product inventory;
identifying a demand pattern associated with the demand data for each of the one or more rotable parts;
forecasting a future demand associated with the one or more rotable parts for at least one future demand period based on the identified demand pattern;
establishing, for the at least one future demand period, an inventory level associated with each of the one or more rotable parts based on the future demand and a predetermined customer service level; and
adjusting a manufacturing schedule associated with the one or more rotable parts based on the established inventory level.

2. The method of claim 1, wherein collecting demand data includes:
receiving a sales order from a customer, the sales order including a request for at least one rotable part; and
recording the customer request for the at least one rotable part as demand data associated with the at least one part.

3. The method of claim 2, wherein collecting demand data further includes:
identifying a superseding part associated with the at least one rotable part; and
recording the customer request for the at least one rotable part as demand data associated with the superseding part.

4. The method of claim 1, further including:
identifying a superseding part associated with a respective rotable part; and
recording future demand data associated with the respective rotable part as future demand data associated with the superseding part.

5. The method of claim 1, wherein forecasting a future demand includes estimating, based on a remanufacturing parts schedule, a lead time associated with fulfilling a rotable part request.

6. The method of claim 1, wherein forecasting a future demand includes:
statistically analyzing the demand pattern associated with the one or more rotable parts;
selecting a demand model corresponding to the demand pattern based on the statistical analysis; and
applying the selected demand model to the demand data to estimate the future demand for one or more future demand periods.

7. The method of claim 6, wherein estimating the future demand includes extrapolating the demand data over a predetermined time period based on the selected demand model.

8. A computer-readable medium for use on a computer system, the computer-readable medium having computer-executable instructions for performing the method of claim 1.

9. A method for forecasting a demand for rotable parts comprising:
collecting demand data for one or more rotable parts associated with a product inventory;
identifying whether there are any superseding parts corresponding with the one or more rotable parts;
recording, for each rotable part with a corresponding superseding part, the demand data for the rotable part as demand data associated with the superseding part;
identifying a demand pattern associated with the demand data;
forecasting a future demand associated with each of the rotable parts and superseding parts for at least one future demand period based on the identified demand pattern; and
establishing, for the at least one future demand period, an inventory level associated with each of the rotable parts and the superseding parts based on the future demand and a predetermined customer service level.

10. The method of claim 9, further including adjusting a manufacturing schedule associated with the one or more rotable parts based on the established inventory level.

11. The method of claim 9, further including:
identifying a superseding part associated with a respective rotable part; and
recording future demand data associated with the respective rotable part as future demand data associated with the superseding part.

12. The method of claim 9, wherein forecasting a future demand includes estimating, based on a remanufacturing parts schedule, a lead time associated with fulfilling a rotable parts request.

13. The method of claim 9, wherein forecasting a future demand includes:
statistically analyzing the demand pattern associated with the one or more rotable parts;
selecting an demand model corresponding to the demand pattern based on the statistical analysis; and
applying the selected demand model to the demand data to estimate the future demand for one or more future demand periods.

14. A part demand forecasting method, comprising:
collecting information about at least one sales transaction including:
recording, from each sales transaction, a customer request for a part; and
recording whether or not the customer is willing to purchase the part on an exchange basis by exchanging a used version of the requested part as part of the sales transaction;
forecasting demand for rotable parts based on the collected information; and
displaying information regarding the forecasted demand.

15. The method of claim 14, wherein the method further includes recording a demand tally for each part sold on an exchange basis.

16. The method of claim 15, wherein forecasting demand includes determining a total number of demand tallies recorded during a predetermined time period;
determining a remanufacturing lead time for the requested part; and
determining a lead time demand value, based on the total number of demand tallies recorded during the predetermined time period, a number of demand tallies corresponding to the remanufacturing lead time for the part.

17. The method of claim 16, wherein forecasting demand includes using a Poisson forecast calculation to determine, from the lead time demand value, the number of rotable versions of the part that should be maintained in stock in order to meet a predetermined level of customer service.

18. The method of claim 14, wherein collecting information includes recording, from each sales transaction, a customer request for a part, including whether the customer requested a new version of the part or a rotable version of the part.

19. The method of claim 14, further including recording part availability, including whether a new version of the requested part is available for sale to the customer at the time of the request or within a predetermined time period thereafter and whether a rotable version of the requested part is available for sale to the customer at the time of the request or within a predetermined time period thereafter.

20. The method of claim 14, further including forecasting demand for new parts based on the recorded information.
